(19) United States
(12) Patent Application Publication
(10) Pub. No.: US 2015/0126113 A1
(43) Pub. Date: May 7, 2015

(54) NEAR FIELD COMMUNICATION TRANSCEIVER SYSTEM

(71) Applicant: TK Holdings Inc., Auburn Hills, MI (US)

(72) Inventors: Leonard CECH, Brighton, MI (US); Craig WHITE, Grosse Pointe, MI (US); Koshan MAHDL, Berlin (DE)

(73) Assignee: TK Holdings Inc., Auburn Hills, MI (US)

(21) Appl. No.: 14/532,660

(22) Filed: Nov. 4, 2014

Related U.S. Application Data
(60) Provisional application No. 61/900,168, filed on Nov. 5, 2013.

(51) Int. Cl. H04B 5/00; H04B 5/02

(52) U.S. Cl. CPC H04B 5/0012; H04B 5/02; H04B 5/0075; H04B 5/0037
USPC 455/41.1; 455/90.2

(57) ABSTRACT

A transceiver system to detect and transfer information from a capacitive based communication system to a personal electronic device having near field communication capabilities includes a transceiver. The transceiver includes a first near field communication device and a signal detection and decoding circuit coupled to the first near field communication device. The signal detection and decoding circuit is tuned to detect a capacitive signal.

### CROSS REFERENCE TO RELATED APPLICATIONS

The present application claims priority to and the benefit of U.S. Provisional Patent Application No. 61/900,168 filed on Nov. 5, 2013. The foregoing provisional application is incorporated by reference herein in its entirety.

### BACKGROUND

This application relates generally to the field of Near Field Communication (NFC) and capacitive coupling methods.

NFC is a defined standard for both passive devices (RFID stickers or pads) and active devices (smartphones) which supports the ability to automate functions such as cellular pairing or direct exchange of information. NFC works through inductive coupling between an active source and an active or passive peer in direct proximity (within a distance, such as several inches). The standard carrier frequency for NFC is 13.56 Mhz. For passive NFC devices (e.g., RFID), the power required to facilitate the communication between another NFC device may be supplied through the inductive coupling circuit. Increasingly, personal electronics, such as smart phones, include a NFC antenna and other communication supporting components. For example, to support the direct transfer of information from one phone to another, the phones may simply be placed in direct proximity, and data transfer may be initiated through a user interface.

Capacitive coupling methods have been disclosed (see, e.g., U.S. patent application Ser. No. 13/735,816 and U.S. Provisional Application No. 61/734,848, and 61/793,319; the three foregoing applications are incorporated by reference herein) which can detect the presence of an occupant through capacitive coupling and also transmit a coded information signal through the occupant. Personal electronics, which contain a tuned detection circuit at the capacitive sensing carrier frequency (typically between 10 Khz and 300 Khz) and which are in proximity to the occupant, may be used to detect, demodulate and decode the coded information signal. However, cellular phones and other electronic devices do not typically include detection and information decoding components to support this type of communication.

Therefore, a system that can detect and transfer coded information from a capacitive based communication system to a personal electronic device having an NFC system is desirable. Furthermore, it may be advantageous to provide a low-cost, after-market, device to facilitate this communication.

### SUMMARY

According to an exemplary embodiment disclosed herein, a transceiver system to detect and transfer information from a capacitive based communication system to a personal electronic device having near field communication capabilities includes a transceiver. The transceiver includes a first near field communication device and a signal detection and decoding circuit coupled to the near field communication device. The signal detection and decoding circuit is tuned to detect a capacitive signal.

According to an alternative embodiment disclosed herein, a method of detecting and transferring information from a capacitive based communication system to a personal electronic device having near field communication capabilities includes providing a transceiver, detecting a capacitive signal with a signal detection and decoding circuit, transferring information between the signal detection and decoding circuit and a first near field communication device, and transferring information from the first near field communication device to a second near field communication device. The transceiver includes the first near field communication device and a signal detection and decoding circuit coupled to the near field communication device. The signal detection and decoding circuit is tuned to detect the capacitive signal. The second near field communication device is coupled to an electronic device.

According to yet another alternative embodiment, a system to electronically couple an electronic device, located in proximity to a person, to a network, includes a sensing electrode located proximate to the person a sensor circuit configured to provide a signal having a particular frequency and power to the sensing electrode to thereby create an electric field proximate to the person and a transceiver. The transceiver includes a first near field communication device, and a signal detection and decoding circuit coupled to the near field communication device. The signal detection and decoding circuit is tuned to detect the signal. The electronic device includes a second near field communication device and is configured to detect an inductive signal of the first near field communication device.

### BRIEF DESCRIPTION OF THE DRAWINGS

FIG. 1 is a schematic drawing which illustrates a transceiver system.

FIG. 2 is a schematic drawing which illustrates a transceiver system integrated into an electronic device (e.g., a mobile phone).

FIG. 3 is a schematic side view of a vehicle interior showing a system for facilitating the communication between an electronic device and the vehicle.

FIG. 4 is a schematic view of a system for facilitating the communication between an electronic device and a human-machine interface (HMI) via a standing person.

FIG. 5 is a schematic view of a system for facilitating the communication between an electronic device and a human-machine interface (HMI), wherein the system is implemented in a front and rear seat configuration.

### DETAILED DESCRIPTION

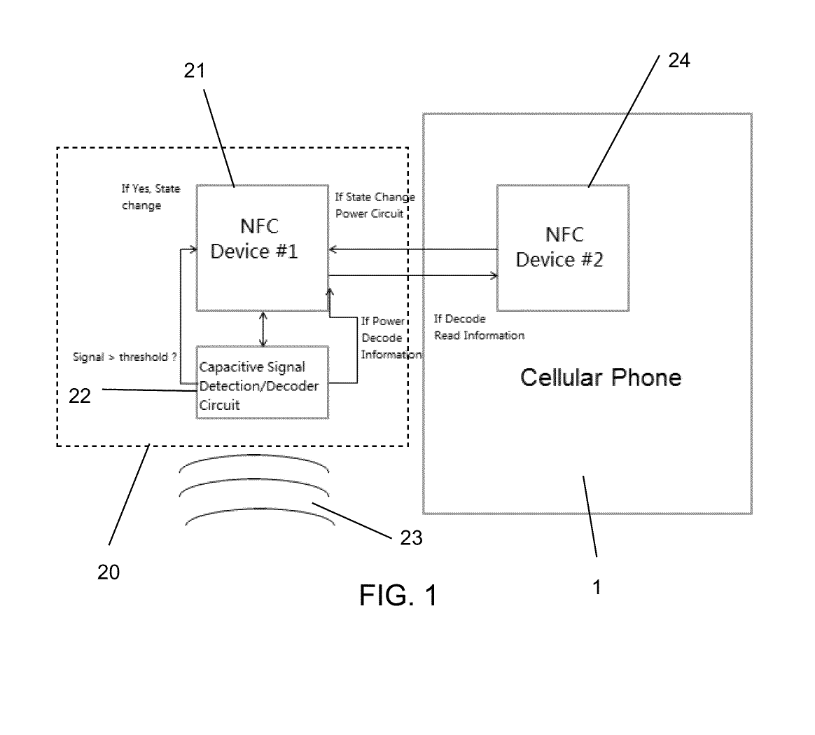

Referring to FIG. 1, a transceiver system is disclosed which may be used to detect and transfer coded information from a capacitive based communication system, which may produce a capacitive signal 23, to a personal electronic device 1 (e.g., a cellular phone) that may include a second Near Field Communication (NFC) device 24 which may consist of a NFC antenna and communication supporting components. According to an exemplary embodiment, a transceiver 20 may be packaged within a case of the electronic device 1 (e.g., a cellular phone case), on a sticker affixed to the electronic device 1 (including, e.g., the electronic device case), or within a plug-in attachment of the electronic device 1 (e.g., a microphone jack, a USB port, a charger port, etc.). It should be understood by those skilled in the art, that while only some locations for a transceiver 20 have been disclosed herein, a transceiver 20 may be packaged (i.e., positioned, located, etc.) in any suitable form, location, or combination of forms or locations.

A transceiver 20 includes a first NFC device 21 in the form of a standard NFC communication chipset (e.g., passive or active mode) and a capacitive signal detection and decoding circuit 22. The NFC communication chipset (first NFC device 21) may be connected to the capacitive signal detection and decoding circuit 22 which is tuned to detect a capacitive signal 23 (e.g., a capacitive seat sensor carrier signal). Upon detection of a capacitive signal 23, the NFC communication chipset (first NFC device 21) may decode any coded information carried by the capacitive signal 23. According to an exemplary embodiment, such coded information may be used for safety purposes (e.g., to disable a device, or certain features of a device, while driving) and convenience and comfort purposes (e.g., to disable/block an electronic device, to pair an electronic device, or to transfer data between a vehicle and an electronic device). It should be understood by those skilled in the art that coded information carried by a capacitive signal 23 could be used for other purposes, according to other exemplary embodiments.

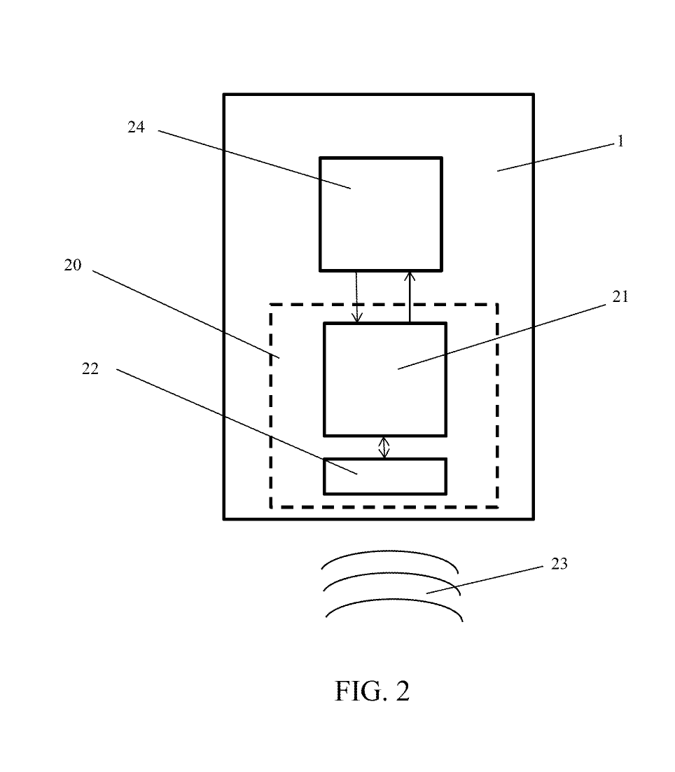

A transceiver 20 includes a first NFC device 21 in the form of a non-powered passive mode NFC device which is coupled (e.g., electrically coupled) to the capacitive signal detection and decoding circuit 22. The non-powered passive mode NFC device (first NFC device 21) is coupled (e.g., affixed, attached, connected, etc.) to an electronic device 1 (e.g., a cellular phone) and positioned within an inductive range of a second NFC device 24 in the form of a NFC antenna and communication supporting components provided (i.e., included) within the electronic device 1. According to this exemplary embodiment, the capacitive signal detection and decoding circuit 22 may be configured so as to activate electronically. For example, the capacitive signal detection and decoding circuit 22 may activate when a sufficient power level (i.e., impedance level), representing a threshold circuit state, is achieved in a tuned detection circuit. A purpose of this state change may be to indicate a presence of an electronic device in proximity to a capacitive sensor (e.g., a capacitive seat sensor), and thereby change an inductive signal in the first non-powered passive mode NFC device (first NFC device 21) such that this condition (i.e., the state change) may be detected by the second NFC device 24, which is provided within an electronic device 1, such as a cellular or mobile telephone. As shown in FIG. 2, the transceiver 20, may be integrated into the mobile telephone. As a result of the arrangement shown in FIG. 2, it is possible for the system to be implemented by modifying a telephone to include the transceiver 20 and avoid the need for the transceiver to be an add on or supplemental device or element. For example, the transceiver 20 can be implemented by providing an integrated circuit (IC) chip connected to an antenna. An antenna already included in the phone may be utilized.

The second NFC device 24 is in the form of a powered (i.e., active) NFC device and may use a polling technique in order to detect the presence of other target communication devices within proximity of the powered NFC device. The powered NFC device (second NFC device 24) may detect the presence of a passive NFC device (first NFC device 21) through a modified inductive signal induced by a transceiver 20. In this case, an inductive field created by an inductive circuit may be used to power the transceiver 20 to support information transfer between a detected capacitive sensing carrier frequency and a passive NFC device (first NFC device 21). An inductive field may also be used for the subsequent transfer of information through NFC communication protocol from a passive NFC device (first NFC device 21) to an electronic device 1 (e.g., a cellular or mobile phone) with an active NFC device (second NFC device 24). According to this exemplary embodiment, when a capacitive sensing carrier frequency is not detected, a state change in a tuned detection circuit and communication between passive and active NFC devices (first and second NFC devices 21, 24) may not occur.

A system may dependently associate the physical presence of an occupant with a location of an electronic device. Such a system may allow one-way or two-way communication between a fixed network and the electronic device through an occupant, in order to dependently establish control/communication parameters of the device, as well as software application activation, based on a specified position of the device.

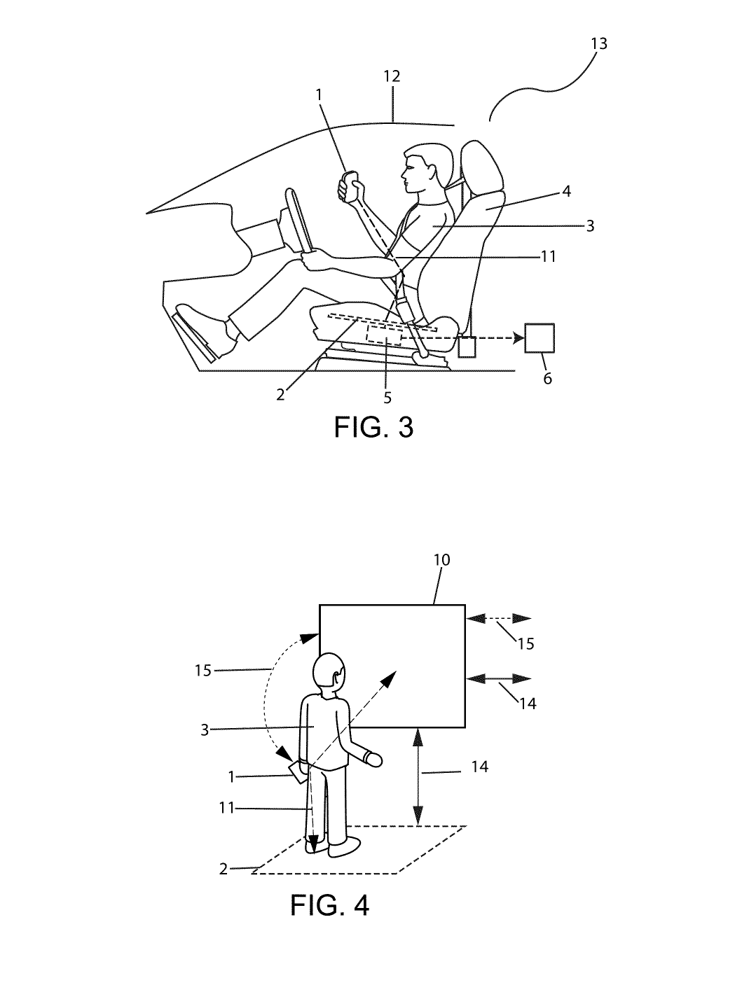

As shown in FIG. 3, an electric field coupling network may be used to electronically couple or pair a fixed communications network, such as a vehicle communications bus 6, with an electronic device 1. A driver 3 of a vehicle 12 may be seated on a vehicle seat 4, and an electronic device 1 may be coupled to the driver (e.g., an electronic device 1 may be held in the hand of the driver 3, in a pocket of the driver's clothes, or in any other location that is sufficiently proximate to the driver). A system 13 used to electronically couple an electronic device to a network may include a capacitive sensor pad 2 provided in a vehicle seat 4 within a vehicle 12. While sensor pad 2 may be provided in a driver's seat 4 of a vehicle, this disclosure is not intended to limit the possible locations in which a sensor pad may be located. Therefore, according to alternative embodiments of this disclosure, a sensor pad could be located anywhere in a vehicle interior (i.e. in a passenger seat, the vehicle floor, an arm rest, the steering wheel, a cup holder, etc.).

Referring to FIGS. 3-5, and according to various embodiments of this disclosure, a sensing electrode, which may be configured as a sensor pad 2, may be able to detect the presence or occupancy of a person or object that is positioned within a proscribed location. Further, sensor pad 2 may be configured to detect various characteristics of an object, such as its position on a seat. Sensor pad 2 may also be configured to discriminate or categorize the object (e.g., person, baby seat, shopping bag, etc.), and to detect other characteristics of the object (e.g., stature, position, loading, etc.). In addition, sensor pad 2 may be provided as a component of another system, such as an occupant detection or classification system.

Referring to FIGS. 3-5, and according to various embodiments of this disclosure, a system 13 may be configured to transmit a signal 11, such as a capacitive signal 23, through a person positioned within a proscribed location. For instance, signal 11 may have a particular frequency and power, and the frequency of signal 11 may be configured to allow it to be redistributed through the person via electric field coupling when the person is positioned within a proscribed location. Such a signal 11 may be configured so that it is not strong enough to be transmitted through the air surrounding a person positioned within a proscribed location.

According to an exemplary embodiment shown in FIG. 3, sensor pad 2 may transmit a signal 11, which may be configured to be redistributed via electric field coupling through driver 3 that is sitting on seat 4. According to an alternative embodiment shown in FIG. 4, a sensor pad may be disposed within a floor, be configured to transmit a signal 11 to a person 3, who is standing over sensor pad 2. Signal 11 may be configured to be redistributed through person 3 via electric field coupling.

Sensor pad 2 may also be electronically coupled to support electronics 5 which may be configured to measure the amount of electric field coupling between sensor pad 2 and objects proximate the sensor pad. According to an exemplary embodiment shown in FIG. 3, the support electronics 5 may be, in turn, electronically coupled to a vehicle communication bus 6. The capacitive sensing subsystem employed with the system may be similar to the systems disclosed in U.S. Pat. No. 6,392,542 and U.S. Published Application No. 2007/0200721 (both incorporated by reference herein).

As shown in FIG. 3, an electronic device 1 may be configured to detect signal 11 when signal 11 is transmitted through a person, and the electronic device 1 is coupled to the person. The electronic device 1 may be coupled to the person through the transceiver system described above with reference to FIGS. 1 and 2. According to the embodiment shown in FIG. 3, an electronic device 1 may be configured to detect signal 11 when electronic device 1 is positioned within a proscribed location, such as the driver's seat of a vehicle. The detection of the signal may be conducted utilizing a transceiver 20 including a capacitive signal detection and decoding circuit 22. The capacitive signal detection and decoding circuit 22 may be coupled to a first non-powered passive mode NFC device (first NFC device 21). The non-powered passive mode NFC device (first NFC device 21) may be coupled to an electronic device 1 (e.g., a cellular phone) and positioned within an inductive range of a second NFC device 24 in the form of a NFC antenna and communication supporting components provided (i.e., included) within the electronic device 1. The electronic device 1 may then detect the signal 11 as discussed above.

Further, when an electronic device detects the signal 11, a response of the device may be to electronically couple, or interface, with a fixed communications network, such as a vehicle communication bus 6. An electronic device 1 may also include hardware and/or software to facilitate or control the coupling of the electronic device to a fixed communications network.

The signal 11 may be configured to carry particular information used to distinguish it from other signals, such as digital or analog information. Further, the power of the signal 11 may be configured to be sufficiently strong to be transmitted through a person who is coupled to an electric field generated by a sensor circuit, but not sufficient to be transmitted from the person's body. Therefore, an electronic device may be configured to detect the signal 11 only when the person is concurrently coupled to the electronic device and the electric field. When the electronic device detects the signal 11, it may distinguish the signal based on the information contained in the signal.

Upon detection of the signal 11, the electronic device 1 may initiate a pairing process with a fixed communications network in which the electronic device 1 automatically connects to the network. A pairing process may be accomplished in a variety of ways. For example, in order to ensure the security of the connection, the electronic device 1 may initiate the pairing process by transmitting a wireless signal to the network. In order for the network to distinguish the signal transmitted from the electronic device 1, and to ensure the security of the connection between the device and the network, the signal may be configured to have a particular frequency or to carry particular information. The electronic device 1 and the network may perform a variety of processes in order to maintain security therebetween. For example, the device and network may be time-synced and the network may use an algorithm to determine a random frequency pattern that is shared with the electronic device 1. While some examples have been described in which an electronic device may automatically connect with a fixed network, it should be understood that the electronic device 1 disclosed herein may perform a variety of methods in order to connect to a fixed communications network, according to other exemplary embodiments.

The fixed communication network may also initiate a pairing process in order to connect to the electronic device 1. For example, the network may continuously transmit a wireless signal to a surrounding area. Alternatively, the network may transmit a wireless signal to a surrounding area when a person is detected within a proscribed location (e.g., a proscribed location may be proximate a sensing electrode that transmits a capacitive signal). The wireless signal transmitted from the network may use an authorization or identification process establish a secure connection with an electronic device. Such an identification process may require the electronic device 1 to transmit a signal having particular information to the network. Concurrently, the electronic device 1 may be coupled to a capacitive signal that is transmitted from a proscribed location, and the signal may contain particular information. When the electronic device detects the capacitive signal, it may use the particular information contained within the capacitive signal to satisfy the network's authorization or identification process. In order to maintain a secure connection, the electronic device 1 and the network may be time-synced and the network may use an algorithm to determine a random frequency pattern that is shared with the electronic device 1. While some examples have been described in which a network may automatically connect with the electronic device 1, it should be understood that the network and the electronic device 1 disclosed herein may perform a variety of methods in order to automatically establish a connection, according to other exemplary embodiments.

Referring now to FIG. 4, a system that may use electric field coupling to automatically connect to a network is disclosed. The system may include a capacitive sensor pad 2 proximate to a standing person 3 (e.g. the sensor pad may be embedded in a floor). A sensor pad may be positioned so that a person 3 standing thereon is within proximity of a human machine interface (HMI) device (e.g., audio, video, tactile, etc.). The sensor pad shown in FIG. 4 may transmit a signal 11 having a capacitively coupled frequency. In other words, signal 11 may be configured to be redistributed through a person 3 via electric field coupling. When person 3 is positioned within sufficient proximity of a sensor pad 2, an electronic device 1 coupled to person 3 through the transceiver 20 may be electronically coupled to a fixed communications network, such as a HMI device, and any network that is simultaneously electronically coupled to the fixed communications network. Information may be exchanged among each of these networks when electronic device 1 is electronically coupled to a fixed communications network or other network.

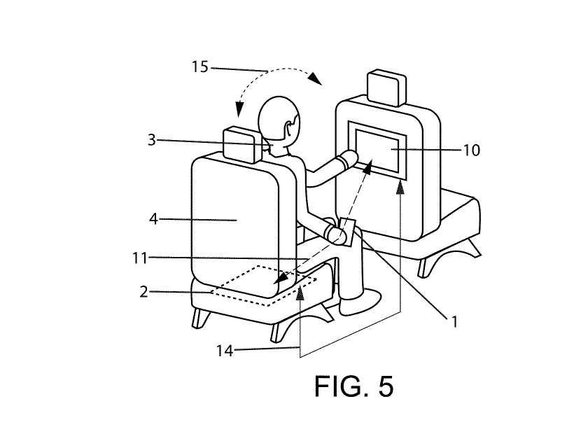

Referring now to FIG. 5, a system that may be implemented in a particular seating configuration in which a seat is positioned behind another seat is shown. Such a seating configuration may be used, for example, within a bus, train, or airplane. A capacitive sensor pad 2 may be mounted within a seat 4 that is configured according to the arrangement shown in FIG. 4. Further, a fixed communications network, such as a human machine interface (HMI) device 10 (e.g., audio, video, tactile, etc.) shown in FIG. 4, may be positioned on a rear facing surface of an adjacent seat, compartment wall, or bulkhead. Sensor pad 2 may be configured to transmit a signal 11 through a person 3 who is seated on seat 4. An electronic device 1 coupled to person 3 through the transceiver 20 may be configured to detect signal 11, and electronically couple to HMI device 10. Therefore, when person 3 is occupied within a particular location proximate a HMI device, a communication state may be established between an device 1, the HMI device, and any wired network 14 or wireless network 15 that is electronically coupled to the HMI device. Such a system may be used to facilitate the exchange of information between sensor pad 2, electronic device 1, and HMI device 10.

According to yet another embodiment of this disclosure, a method to electronically couple an electronic device to a fixed communication network may transmit an electronic signal from a sensing electrode to a person occupying a proscribed location and coupled to the electronic device through the transceiver 20. Based upon detection of the signal by the electronic device, the electronic device may electronically couple the electronic device to the network. In such a method, the signal may be configured to be redistributed through a person via electronic field coupling. Further, the electronic device may have to be coupled to the person through the transceiver 20 in order to detect the signal.

A system or method may use electric field coupling to electronically couple or “pair” an electronic device 1 with a network that may generate a signal having a capacitive coupled frequency. For example, an electrode in a capacitive sensing subsystem may transmit a signal having a capacitive coupled frequency. The signal may be configured to be transmitted across a person who is sufficiently proximate to an electrode or sensing pad generating the signal. A transceiver coupled to an electronic device 1 that is sufficiently proximate to the person's body may detect the signal having a capacitive coupled frequency. An electronic device 1 may be configured to detect a signal from the transceiver which is capable of detecting a signal having a capacitive coupled frequency, and the electronic device 1 may be configured to automatically pair with a network that is electronically coupled to the capacitive sensing subsystem.

A sensor pad and supporting electronics may cooperate with hardware and software added to an electronic device to detect the location and possession of the device. According to an exemplary embodiment, when an electronic device is detected in a particular location, this information may be used, for example, to disable the use of an electronic device in possession of the driver while the vehicle is operational. In a similar fashion, a system may be configured to detect and control an electronic device 1 that is placed on an unoccupied seat (e.g., when a driver places a cell phone on an empty passenger seat).

According to alternative embodiments, a sensor pad may be incorporated into various other vehicle compartments. For example, a sensor pad may be embedded in a cup-holder, a phone receptacle or another location where an electronic device may be placed. According to an alternative embodiment, a sensor pad 2 may be located in a passenger seat, and configured to generate a signal 11 having a capacitive coupled frequency. An electronic device 1 may detect signal 11 via electronic field coupling when the device is placed on the seat, or when the device is otherwise within sufficient proximity of signal 11. When electronic device 1 detects signal 11, various hardware or software of electronic device 1 may automatically control its use while the vehicle is in motion. Also, hardware or software of electronic device 1 may electronically couple or “pair” the device with a vehicle communication bus 6 and enable hands-free technology.

A system to electronically couple an electronic device and a fixed communications network may be utilized in a wide variety of locations, including personal and public transportation vehicles, homes, schools, business locations, and other venues. Advantageously, several personalized and selectable communications modes, which are based on the physical location of an electronic device, may exist for particular systems used to electronically couple an electronic device and a fixed communications network. may be configured to operate in the system may include personalized, selectable communication modes based on physical locations (e.g., a car driver mode, a car passenger mode, a bus mode, a plane mode, a train mode, a theater mode, etc.) where the characteristics of the automated network would be set based on mode (e.g., cell phone ringer disabled in movie theater; hands-free enabled in car driver seat; music/video playback enabled in bus, infotainment system enabled in a plane seat back, etc.).

Advantageously, according to various embodiments of this disclosure, a system 13 may allow a single fixed communications network, such as a HMI, to be customizable by a specific human touch by allowing a user interface to function differently for multiple proximal occupants. In other words, a HMI may distinguish between a person who is positioned within a particular location, and a person positioned in an alternative location. For example, an HMI in the form of a dash-mounted touch screen in a vehicle may be configured to function in a first manner with respect to a driver of the vehicle, and in a second manner for a passenger of the vehicle.

A system 13 may be configured so that the electric field characteristics of the sensor pad change from a first configuration (i.e., a normal operating configuration) to a second configuration when a vehicle event occurs. A signal having a second configuration may enable an alternative means of network communications between an electronic device 1 and a fixed communications network. For example, if a vehicle experiences an event, such as a vehicle collision, or a roll-over, sensor pad 2 may transmit a signal having a second configuration which all electronic devices within the vehicle compartment may be configured to detect. When an electronic device detects a signal having a second configuration, the device may be configured to automatically initiate an emergency phone call.

Advantageously, one skilled in the art will appreciate that a system may be configured to provide enhanced security when electronically coupling to an electronic device by dependently relying on occupancy or physical possession of a particular device. Further, additional security may be provided, in addition to other limitations, such as requiring a password, an encryption, and other wireless connectivity limitations.

For purposes of this disclosure, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature.

The present disclosure has been described with reference to example embodiments, however persons skilled in the art will recognize that changes may be made in form and detail without departing from the spirit and scope of the disclosed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. For example, the sensing electrode may be computer driven. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor. By way of example, such computer or machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of computer or machine-readable media. Computer or machine-executable instructions comprise, for example, instructions and data which cause a general purpose computer, special purpose computer, or special purpose processing machines to perform a certain function or group of functions. Software implementations of the present disclosure could be accomplished with standard programming techniques with rule based logic and other logic to accomplish the various connection steps, processing steps, comparison steps and decision steps.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

What is claimed is:

1. A transceiver system to detect and transfer information from a capacitive based communication system to a personal electronic device having near field communication capabilities comprising:
a transceiver which includes:
a first near field communication device; and
a signal detection and decoding circuit coupled to the first near field communication device,
wherein the signal detection and decoding circuit is tuned to detect a capacitive signal.

2. The transceiver system of claim 1, wherein the transceiver is configured to be coupled to an electronic device.

3. The transceiver system of claim 2, further comprising an electronic device case, wherein the transceiver is attached to the electronic device case.

4. The transceiver system of claim 2, wherein the transceiver is configured to attach to the electronic device by means of an adhesive.

5. The transceiver system of claim 2, further comprising a plug-in attachment, wherein the transceiver is within the plug-in attachment and wherein the plug-in attachment is configured to be plugged into an electronic device.

6. The transceiver system of claim 2, wherein the first near field communication device is a passive near field communication device

7. The transceiver system of claim 6, wherein the signal detection and decoding circuit includes a tuned detection circuit, and wherein the signal detection and decoding circuit is configured to undergo a state change when a predetermined signal level is reached in the tuned detection circuit as a result of a detection of the capacitive signal.

8. The transceiver system of claim 7, wherein the transceiver system is configured so that, when the state change occurs, an inductive signal change is caused in the first near field communication device, and wherein the inductive signal change is such that the inductive signal change may be detected by a second near field communication device.

9. The transceiver system of claim 8, wherein the transceiver system is configured so that, the transceiver may be powered by a first inductive field in order to support information transfer between the capacitive signal and the first near field communication device.

10. The transceiver system of claim 9, wherein the transceiver system is configured so that, a second inductive field may be used for the transfer of information from the first near field communication device to the second near field communication device.

11. The transceiver system of claim 9, wherein the transceiver system is configured so that, when the capacitive signal is not detected by the tuned detection circuit, the state change in the signal detection and decoding circuit does not occur and communication between the first near field communication device and the second near field communication device does not occur.

12. The transceiver system of claim 2, wherein the first near field communication device is an active near field communication device.

13. A method of detecting and transferring information from a capacitive based communication system to a personal electronic device having near field communication capabilities comprising:
providing a transceiver which includes:
a first near field communication device; and
a signal detection and decoding circuit coupled to the first near field communication device,
wherein the signal detection and decoding circuit is tuned to detect a capacitive signal;
detecting the capacitive signal with the signal detection and decoding circuit;
transferring information between the signal detection and decoding circuit and the first near field communication device; and
transferring information from the first near field communication device to a second near field communication device,
wherein the second near field communication device is coupled to an electronic device.

14. The method of claim 13, wherein the first near field communication device is a passive near field communication device, wherein the second near field communication device is an active near field communication device, and wherein an inductive field generated by the second near field communication device is used to power the transceiver to support information transfer between the signal detection and decoding circuit and the first near field communication device.

15. The method of claim 13,
wherein the signal detection and decoding circuit includes a tuned detection circuit,
wherein the signal detection and decoding circuit is configured to undergo a state change when a predetermined signal level is reached in the tuned detection circuit as a result of a detection of the capacitive signal,
wherein the transceiver system is configured such that, when the state change occurs, an inductive signal change is caused in the first near field communication device,
wherein the inductive signal change is such that the inductive signal change may be detected by the second near field communication device,
wherein the transceiver system is configured such that, the transceiver may be powered by a first inductive field in order to support information transfer between the capacitive signal and the first near field communication device,
wherein the transceiver system is configured such that, a second inductive field may be used for the transfer of information from the first near field communication device to the second near field communication device, and
wherein the transceiver system is configured such that, when the capacitive signal is not detected by the tuned detection circuit, the state change in the signal detection and decoding circuit does not occur and communication between the first near field communication device and the second near field communication device does not occur.

16. A system to electronically couple an electronic device, located in proximity to a person, to a network, comprising:
a sensing electrode located proximate to the person;
a sensor circuit configured to provide a signal having a particular frequency and power to the sensing electrode to thereby create an electric field proximate to the person;
a transceiver which includes:
a first near field communication device; and
a signal detection and decoding circuit coupled to the first near field communication device,
wherein the signal detection and decoding circuit is tuned to detect the signal,
wherein the electronic device includes a second near field communication device and is configured to detect an inductive signal of the first near field communication device.

17. The system of claim 16, wherein the signal detection and decoding circuit includes a tuned detection circuit, and wherein the signal detection and decoding circuit is configured to undergo a state change when a predetermined signal level is reached in the tuned detection circuit as a result of a detection of the signal.

18. The system of claim 17, wherein the system is configured such that, when the state change occurs, the inductive signal is induced in the first near field communication device.
